(19) United States
(12) Patent Application Publication
(10) Pub. No.: US 2015/0042200 A1
(43) Pub. Date: Feb. 12, 2015

(54) ROTOR OF BUILT-IN PERMANENT MAGNET MOTOR AND BUILT-IN PERMANENT MAGNET MOTOR USING SAME

(71) Applicant: Danfoss Tianjin Ltd., Tianjin (CN)

(72) Inventors: Li Yao, Tianjin (CN); Wanzhen Liu, Tianjin (CN); Zhenyu Wang, Tianjin (CN); Yan Lin, Tianjin (CN)

(21) Appl. No.: 14/360,433

(22) PCT Filed: Nov. 23, 2012
(86) PCT No.: PCT/CN2012/085164

§ 371 Date: Oct. 27, 2014

(30) Foreign Application Priority Data
Nov. 25, 2011 (CN) 201110380616.2

(51) Int. Cl. H02K 1/27

(52) U.S. Cl. CPC H02K 1/276
USPC 310/216.057; 310/216.091

(57) ABSTRACT

A rotor (24) of an interior permanent magnet motor and an interior permanent magnet motor (20) are disclosed. The rotor (24) of the interior permanent magnet motor includes a rotor iron core (25); a plurality of permanent magnets (27), where the plurality of permanent magnets (27) are spaced apart inside the rotor iron core (25); and a plurality of air slots (30), disposed at end portions of adjacent permanent magnets (27) and close to an outer circumference of the rotor, and adapted to generate air gap flux density between the outer circumference of the rotor and an inner circumference of a stator of the interior permanent magnet motor, and the air gap flux density being in an analogous sinusoidal shape.

### CROSS-REFERENCE TO RELATED APPLICATION

This application is entitled to the benefit of and incorporates by references subject matter disclosed in International Patent Application No. PCT/CN2012/085164, filed on Nov. 23, 2012 and Chinese Patent Application No. 201110380616.2 filed on Nov. 25, 2011.

### FIELD OF THE INVENTION

The present invention relates to the field of permanent magnet motors, and more particularly to a rotor of an interior permanent magnet motor and an interior permanent magnet motor using the rotor.

### BACKGROUND

Generally, a permanent magnet motor such as a brushless Direct Current (DC) motor has permanent magnets installed on the core part of a rotor to generate a rotational driving force. Based on the way of installing the permanent magnets on the core part of the rotor, the permanent magnet motor may be a surface-mounted permanent magnet motor or an interior permanent magnet motor.

Typically, an interior permanent magnet motor has a plurality of permanent magnets installed on a core part of a rotor. The interior permanent magnet motor includes: a stator, a coil winding the stator, and a rotor. The rotor is rotatably disposed in the stator. Conventionally, in order to generate a sinusoidal air-gap magnetic field, the rotor is usually in an irregular round shape so that an uneven air gap is generated between an inner circumference of the stator and an outer circumference of the rotor. However, this may increase difficulty of machining a permanent magnet motor to some extent, and this may also make it difficult to ensure that the stator and the rotor are coaxial during assembly of the permanent magnet motor.

In view of the above, it is necessary to provide a new rotor of an interior permanent magnet motor, which can avoid use of an irregular round rotor, and can reduce the difficulty of ensuring that the stator and the rotor are coaxial during assembly.

### SUMMARY OF THE INVENTION

Embodiments of the present invention aim at solving at least one aspect of the problems and defects in the conventional art.

According to an aspect, a rotor of an interior permanent magnet motor is provided, which may improve distribution of an air-gap magnetic field of the interior permanent magnet motor or may change a magnetic flux path.

According to another aspect, an interior permanent magnet motor is provided, which can avoid use of an irregular round rotor.

According to yet another aspect, an interior permanent magnet motor is provided, which can reduce difficulty of aligning the stator and the rotor coaxially during assembly.

According to yet another aspect, an interior permanent magnet motor using the above rotor is provided.

According to an aspect, a rotor for an interior permanent magnet motor includes: a rotor iron core; a plurality of permanent magnets, where the plurality of permanent magnets are spaced apart inside the rotor iron core; and a plurality of air slots, disposed at end portions of adjacent permanent magnets and close to an outer circumference of the rotor, adapted to generate approximately-sinusoidal flux density between the outer circumference of the rotor and an inner circumference of a stator of the interior permanent magnet motor.

Preferably, the air slots include permanent magnet slot gaps disposed at each end of the permanent magnets and slots disposed in vicinity of the permanent magnet slot gaps.

In an embodiment, the permanent magnet slot gaps are in an irregular or regular polygon shape.

Preferably, each end of the permanent magnet slot gaps is provided with two relatively staggered slots, and the slots are incline elongated or rod-shaped slots relative to the permanent magnets.

Preferably, the rotor is a regular cylinder.

Preferably, the rotor may further include a plurality of permanent magnet slots disposed therein, and the permanent magnets are disposed in the permanent magnet slots.

Preferably, there are four permanent magnets, and the four permanent magnets are four cuboid-shaped permanent magnets in a same size. The plurality of permanent magnets form a cube shape together.

Preferably, the rotor iron core is in a cylindrical shape, and is formed by a plurality of silicon steel sheets laminated together.

In an embodiment, the rotor iron core further includes a rotary shaft disposed in its center.

According to another aspect of the present invention, an interior permanent magnet motor is provided. The interior permanent magnet motor includes: a stator and the above rotor. The rotor is rotatably disposed in the stator, and is spaced apart at a distance from the stator.

Preferably, the stator includes a cylindrical stator iron core, a plurality of stator teeth extending inwards along a radial direction of the stator, stator slots distributed between the plurality of stator teeth and coils winding the stator teeth respectively to generate a rotating magnetic field.

Preferably, an air gap between an inner circumference of the stator and an outer circumference of the rotor is an annular air gap with an even width.

In a permanent magnet motor, the strength of the torque fluctuations may affect operation performance of the permanent magnet motor, and may be optimized when designing the permanent magnet motor. In the embodiments of the present invention, torque fluctuations of the interior permanent magnet motor is lessen by way of changing distribution of air-gap flux density by changing rotor magnetic resistance of the interior permanent magnet motor. Compared with the conventional way of using an uneven air gap, the embodiments of the present invention have advantages, such as convenient and simple machining and great tolerance, and an advantage of reducing difficulty of making the stator and the rotor coaxially during assembly.

### BRIEF DESCRIPTION OF THE DRAWINGS

Exemplary embodiments of the present invention will be described with the accompanying schematic drawings, where corresponding reference signs in the drawings indicate corresponding components.

FIG. 1 is a schematic diagram showing a cross-sectional view of a conventional interior permanent magnet motor.

FIG. 2 is a schematic diagram showing a cross-sectional view of an interior permanent magnet motor according to an embodiment of the present invention.

FIG. 3 illustrates a graph showing air-gap flux density between an inner circumference of a stator and an outer circumference of a rotor of the interior permanent magnet motor in FIG. 1 and a graph showing air-gap flux density between an inner circumference of a stator and an outer circumference of a rotor of the interior permanent magnet motor in FIG. 2 within an electrical angle of 180°.

FIG. 4 illustrates respective graphs of torque fluctuations of the interior permanent magnet motor in FIG. 1 and the interior permanent magnet motor in FIG. 2 relative to time.

### DETAILED DESCRIPTION

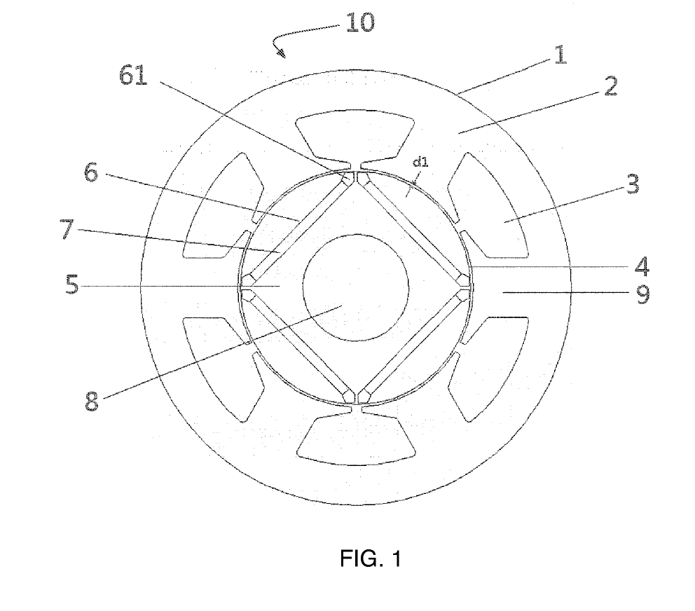

The technical solution of the present invention will be further described below in detail with reference to embodiments and FIGS. 1-4. In the specification, the same or similar reference signs represent the same or similar components. The following description about the embodiments of the present invention with reference to the accompanying drawings aims to explain the general inventive concept of the present invention, but should not be construed as a limitation to the scope of the present invention.

FIG. 1 is a cross-sectional view of a traditional interior permanent magnet motor 10. The interior permanent magnet motor 10 includes: a stator 1, a coil (not shown in FIG. 1) winding the stator 1 and a rotor 4. The rotor 4 is rotatably disposed in the stator 1.

The stator 1 includes: a cylindrical stator iron core 2 formed by a plurality of silicon steel sheets laminated together; stator teeth 9 formed in the stator iron core 2 and extending inwards along a radial direction of the stator iron core 2; stator slots 3 distributed between the stator teeth 9; and coils (not shown) winding the stator teeth 9.

The rotor 4 includes: a rotor iron core 5 formed by a plurality of silicon steel sheets laminated together, the rotor iron core 5 being disposed in a cylindrical cavity of the stator 1 and being separated from the cylindrical cavity of the stator 1 at a predetermined distance; a plurality of permanent magnet holes 6 formed in the rotor iron core 5; and a plurality of permanent magnets 7, the permanent magnets 7 being respectively inserted into the permanent magnet holes 6. Generally, after the permanent magnets 7 are respectively inserted into the permanent magnet holes 6, a permanent magnet gap 61 is formed at an end portion of a permanent magnet 7. A rotary shaft 8 is inserted in a cylindrical cavity formed at the center of the rotor 4, and thereby rotates together with the rotor iron core 5.

When an electric current is supplied to the coils winding the stator teeth 9 of the traditional permanent magnet motor 10 with the above structure, polarities of the coils are changed sequentially, a rotating magnetic field is generated between the stator 1 and the rotor 4, and a magnetic field of the rotor 4 rotates with the rotating magnetic field, and generates a rotational driving force. Therefore, the rotor iron core 5 rotates and makes the rotary shaft 8 rotate together.

In the interior permanent magnet motor 10, as the width of a gap d1 between the inner circumference of the stator 1 and the outer circumference of the rotor 4 is uniform, the permanent magnets 7 inserted to the rotor 4 will generally generate non-sinusoidal air-gap flux density along the gap d1, which may increase torque fluctuation for a permanent magnet motor supplied with a sine wave current. As a result, when the rotor 4 rotates, there will be vibration and noise will increase. Accordingly, efficiency of the interior permanent magnet motor 10 is reduced.

Conventionally, in order to generate a sinusoidal air-gap magnetic field, the rotor 4 is usually in an irregular round shape so that an uneven air gap is generated between the inner circumference of the stator and the outer circumference of the rotor. However, this may increase difficulty of machining a permanent magnet motor to some extent, and this may also make it difficult to ensure that the stator and the rotor are coaxial during assembly of the permanent magnet motor.

In view of the above, an interior permanent magnet motor according to the embodiments of the present invention is provided and will be described below with reference to the accompanying drawings.

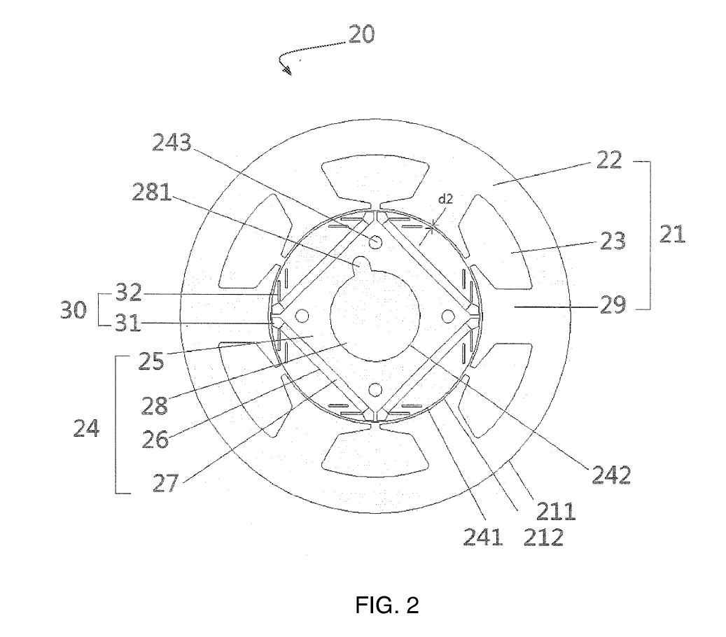

FIG. 2 illustrates an interior permanent magnet motor 20 according to an embodiment of the present invention. The interior permanent magnet motor 20 includes a stator 21 and a rotor 24. The rotor 24 is rotatably disposed in the stator 21, and is spaced apart at a distance from the stator 21. Specifically, the rotor 24 is disposed in a cylindrical cavity of the stator 21. Generally, the rotor 24 is coaxially disposed in the cylindrical cavity. The stator 21 and the rotor 24 are spaced apart at a distance d2.

The stator 21 includes a cylindrical stator iron core 22, a plurality of stator teeth 29 extending inwards along a radial direction of the stator 21, stator slots 23 distributed between the plurality of stator teeth 29 and coils (not shown) respectively winding the stator teeth 29 to generate a rotating magnetic field. As the stator 21 is cylindrical, the stator 21 has an outer circumference 211 and an inner circumference 212.

An air gap between the inner circumference 212 of the stator 21 and an outer circumference 241 (described in detail later) of the rotor 24 is an annular air gap with an even width or an annular air gap with a radial width of d2.

As shown in FIG. 2, the rotor 24 includes: a rotor iron core 25; a plurality of permanent magnets 27, the plurality of permanent magnets 27 being spaced apart inside the rotor iron core 25; and a plurality of air slots 30 disposed on end portions of the adjacent permanent magnets 27 and close to the outer circumference 241 of the rotor 24, adapted to generate approximately sinusoidal flux density in an air gap between the outer circumference 241 of the rotor and the inner circumference 212 of the stator.

According to an embodiment of the present invention, the rotor 24 is in a regular cylinder shape and has an outer circumference 241. The outer circumference 241 of the rotor and the inner circumference 212 of the stator are spaced apart at a distance or gap d2. In addition, the rotor 24 further includes a rotary shaft 28 disposed in its center. In other words, the rotary shaft 28 is disposed in a cylindrical cavity of the cylindrical rotor iron core 25. An inner circumference 242 of the rotor iron core 25 closely fits with the rotary shaft 28, and in addition, a shaft key 281 at the rotary shaft 28 is further provided to be fit into a shaft key hole (not shown) of the rotor iron core 25. Generally, the rotor iron core 25 in a cylindrical shape is manufactured with a plurality of silicon steel sheets laminated together. It can be understood that, the cylindrical rotor iron core 25 and the cylindrical rotary shaft 28 are fit together through the shaft key 281 and the shaft key hole, which form the cylindrical rotor 24. As shown in FIG. 2, in the embodiment of the present invention, the rotor iron core 25 is fixed in the rotor 24 through four screws or bolts 243. It should be noted that, a person skilled in the art can understand that the rotor 24 and the rotary shaft 28 may be connected not only by means of a shaft key, and but also by means of heat shrink and cold pressing.

As shown in FIG. 2, the rotor 24 further includes a plurality of permanent magnet slots 26 disposed in the rotor iron core 25, and the permanent magnets 27 are embedded or inserted in the permanent magnet slots 26. In this embodiment, there are four permanent magnets 27, and the four permanent magnets 27 are in cuboid shapes with the same size. Accordingly, there are four permanent magnet slots 26. The four permanent magnets 27 together form a substantially square or cube shape. Or, as can be seen from the cross section view shown in FIG. 2, the four permanent magnets 27 form a square. However, as known to a person skilled in the art, any number of permanent magnets or permanent magnet slots may be configured in the rotor 24 according to requirements.

After the permanent magnets 27 are respectively inserted into the permanent magnet slots 26, gaps 31 in each permanent magnet slot are formed at each end of a permanent magnet 27. In other words, each end of each of the permanent magnet slots 26 is provided with a permanent magnet slot gap 31. The permanent magnet slot gap 31 is configured to be in an irregular or regular polygon shape. In this embodiment, the permanent magnet slot gap 31 is configured to be an irregular quadrilateral. Certainly, it can be understood that, the permanent magnet slot gap 31 may also be configured a regular triangle or rectangle.

In addition, a slot 32 is disposed in the vicinity of each of the permanent magnet slot gaps 31. Specifically, each end of a permanent magnet slot gap 31 (e.g., on one side of one end) is provided with two relatively staggered slots 32, and the slots 32 are inclined elongated slots or rod-shaped slots relative to the permanent magnets 27. As shown in FIG. 2, one side of each of the permanent magnet slot gaps 31 away from another neighboring or adjacent permanent magnet slot gap 31 is provided with two staggered inclined elongated slots 32.

It can be understood that, in the embodiment of the present invention, an air slot 30 includes a permanent magnet slot gap 31 disposed at each end of the permanent magnets 27 and a slot 32 disposed in the vicinity of the permanent magnet slot gap 31.

In the present invention, in order to achieve the aim of changing a magnetic flux path of the permanent magnets 27, the slots 32 should be mainly configured in a position which is at two ends of a permanent magnet 27 and which is close to the outer circumference 241 of the rotor. The dimension or size of the slots 32 or air slots 30 can be determined according to actual relative positions of the permanent magnets 27 and the outer circumference 241 of the rotor, so as to ensure mechanical torque strength. In an embodiment of the present invention, the number and the incline direction of the air slots may be different from those shown in FIG. 2, and the number and the incline direction of the air slots 30 may be determined according to experimental or simulation results.

In the foregoing description, structures of main components such as the stator 21 and the rotor 24 of the interior permanent magnet motor 20 are mainly described. It can be understood that the interior permanent magnet motor 20 may further include a housing (not shown) and a base plate as well as other common accessories of the stator 21 and the rotor 24. The housing or a connection structure between the housing and the stator will not be described in detail herein.

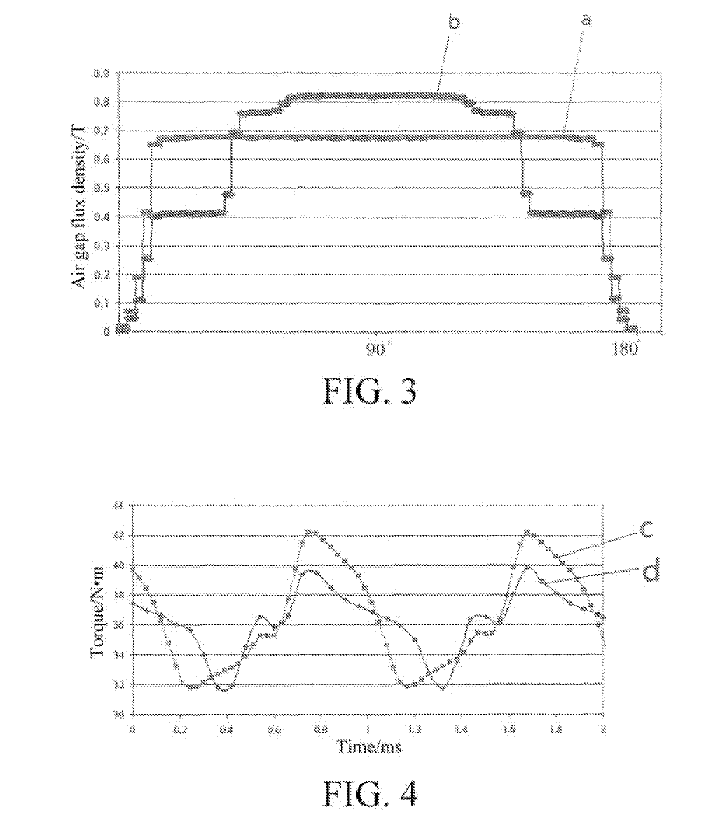

FIG. 3 illustrates a graph showing air-gap flux density between an inner circumference 212 of a stator and an outer circumference 241 of a rotor of the interior permanent magnet motor in FIG. 1 and a graph showing air-gap flux density between an inner circumference of a stator and an outer circumference of a rotor of the interior permanent magnet motor in FIG. 2 within an electrical angle of 180°. As shown by a curve a in FIG. 3, it shows a curve of air gap flux density between the inner circumference of the stator and the outer circumference of the rotor of the interior permanent magnet motor 10 shown in FIG. 1 within an electrical angle of 180°. As can be seen from the curve a, the air gap flux density within the electrical angle of 180° is in a substantially rectangle shape with a flat top. As shown by a curve b in FIG. 3, it shows a curve of air gap flux density between the inner circumference 212 of the stator and the outer circumference 241 of the rotor of the interior permanent magnet motor 20 shown in FIG. 2 is within an electrical angle of 180°. As can be seen from the curve b, the air gap flux density within the electrical angle of 180° is in an approximately sinusoidal shape or a sinusoidal shape. As can be known from comparison of the curve a and the curve b, embodiments of the present invention make the air gap flux density of the interior permanent magnet motor 20 in FIG. 2 much closer to the sinusoidal shape by configuring the air gap slots 32 or the air slots 30.

FIG. 4 illustrates a curve c of torque fluctuations of the interior permanent magnet motor 10 in FIG. 1 relative to time and a curve d of torque fluctuations of the interior permanent magnet motor 20 in FIG. 2 relative to time. As can be known from comparison of the curve c and the curve d, with respect to the conventional interior permanent magnet motor 10 shown in FIG. 1, the torque fluctuations of the interior permanent magnet motor 20 having slots 32 in the embodiments of the present invention are effectively reduced.

In a permanent magnet motor, strength of the torque fluctuations may affect operation performance of the permanent magnet motor, which thus may be optimized when designing the permanent magnet motor. In embodiments of the present invention, the aim of reducing torque fluctuations of the interior permanent magnet motor 20 is achieved by way of changing distribution of air-gap flux density by changing the size of rotor reluctance of the interior permanent magnet motor 20. Compared with the way of using an uneven air gap, the embodiments of the present invention have advantages, such as convenient and simple machining, great tolerance and the like, and also lower difficulty of making the stator and the rotor coaxial during assembly.

Although some embodiments of the general concept of the present invention have been displayed and described, a person of ordinary skill in the art should understand that, changes can be made to these embodiments without departing from the principle and spirit of the general inventive concept of the present invention, and the scope of the present invention is defined by the claims and their equivalents.

What is claimed is:

1-12. (canceled)

13. A rotor for an interior permanent magnet motor, comprising:
a rotor iron core; and
a plurality of permanent magnets, wherein the plurality of permanent magnets are spaced apart inside the rotor iron core; and
a plurality of air slots, disposed at end portions of adjacent permanent magnets and close to an outer circumference of the rotor, adapted to generate air gap flux density between the outer circumference of the rotor and an inner circumference of a stator of the interior permanent magnet motor, the air gap flux density being in an analogous sinusoidal shape.

14. The rotor for the interior permanent magnet motor according to claim 13, wherein
the air slots comprise a permanent magnet slot gap disposed at each end of the permanent magnets and a slot disposed in vicinity of the permanent magnet slot gap.

15. The rotor for the interior permanent magnet motor according to claim 14, wherein
the permanent magnet slot gap is in an irregular or regular polygon shape.

16. The rotor for the interior permanent magnet motor according to claim 14, wherein
each end of the permanent magnet slot gap is provided with two slots, and the two slots are incline elongated or rod-shaped slots relative to the permanent magnets.

17. The rotor for the interior permanent magnet motor according to claim 13, wherein
the rotor is a regular cylinder.

18. The rotor for the interior permanent magnet motor according to claim 17, wherein
the rotor further comprises a plurality of permanent magnet slots disposed therein, and the permanent magnets are disposed in the permanent magnet slots respectively.

19. The rotor for the interior permanent magnet motor according to claim 18, wherein
there are four permanent magnets, the four permanent magnets are four cuboid-shaped permanent magnets with a same size, and the plurality of permanent magnets form a cube together.

20. The rotor for the interior permanent magnet motor according to claim 13, wherein
the rotor iron core is in a cylindrical shape and is formed by a plurality of silicon steel sheets laminated together.

21. The rotor for the interior permanent magnet motor according to claim 13, wherein
the rotor iron core further comprises a rotary shaft disposed in a center of the rotor iron core.

22. An interior permanent magnet motor, comprising:
a stator, and a rotor, rotatably disposed in the stator and spaced apart at a distance from the stator;
wherein the rotor comprises:
a rotor iron core;
a plurality of permanent magnets, wherein the plurality of permanent magnets are spaced apart inside the rotor iron core; and
a plurality of air slots, disposed at end portions of adjacent permanent magnets and close to an outer circumference of the rotor, adapted to generate air gap flux density between the outer circumference of the rotor and an inner circumference of a stator of the interior permanent magnet motor, the air gap flux density being in an analogous sinusoidal shape.

23. The interior permanent magnet motor according to claim 22, wherein
the air slots comprise a permanent magnet slot gap disposed at each end of the permanent magnets and a slot disposed in vicinity of the permanent magnet slot gap.

24. The interior permanent magnet motor according to claim 23, wherein
the permanent magnet slot gap is in an irregular or regular polygon shape.

25. The interior permanent magnet motor according to claim 24, wherein
each end of the permanent magnet slot gap is provided with two slots, and the two slots are incline elongated or rod-shaped slots relative to the permanent magnets.

26. The interior permanent magnet motor according to claim 22, wherein
the rotor is a regular cylinder.

27. The interior permanent magnet motor according to claim 26, wherein
the rotor further comprises a plurality of permanent magnet slots disposed therein, and the permanent magnets are disposed in the permanent magnet slots respectively.

28. The interior permanent magnet motor according to claim 27, wherein
there are four permanent magnets, the four permanent magnets are four cuboid-shaped permanent magnets with a same size, and the plurality of permanent magnets form a cube together.

29. The interior permanent magnet motor according to claim 22, wherein
the rotor iron core is in a cylindrical shape and is formed by a plurality of silicon steel sheets laminated together.

30. The interior permanent magnet motor according to claim 22, wherein
the rotor iron core further comprises a rotary shaft disposed in a center of the rotor iron core

31. The interior permanent magnet motor according to claim 22, wherein
the stator comprises a cylindrical stator core, a plurality of stator teeth extending inwards along a radial direction of the stator, stator slots distributed between the plurality of stator teeth, and coils winding the stator teeth respectively to generate a rotating magnetic field.

32. The interior permanent magnet motor according to claim 22, wherein
an air gap between an inner circumference of the stator and an outer circumference of the rotor is an annular air gap with an even width.
